(19) United States
(12) Patent Application Publication
(10) Pub. No.: US 2012/0054358 A1
(43) Pub. Date: Mar. 1, 2012

(54) Network Relay Device and Frame Relaying Control Method

(75) Inventor: Daisuke Yamada, Nagoya-shi (JP)

(73) Assignee: BUFFALO INC., Nagoya-shi (JP)

(21) Appl. No.: 13/215,248

(22) Filed: Aug. 23, 2011

(30) Foreign Application Priority Data
Aug. 24, 2010 (JP) 2010-186829

(51) Int. Cl. G06F 15/16

(52) U.S. Cl. 709/229

(57) ABSTRACT

A network relay device includes: a plurality of ports to which external devices connect, and configured pre-correlated with types of authentication to be conducted with respect to connected external devices; an authentication process section for conducting, when an external device is connected to the network relay device, mutual authentication between the network relay device and the external device in accordance with the type of authentication that a port to which the external device is connected is configured for; a relay process section for relaying, without authentication being conducted by the authentication process section, frames received through a port configured for a first authentication type, and for relaying frames received through a port configured for a second authentication type, if authentication by the authentication process section has succeeded.

### CROSS REFERENCE TO RELATED APPLICATION

The disclosure of Japanese Patent Application No. 2010-186829, filed on Aug. 24, 2010, is incorporated herein by reference.

### BACKGROUND OF THE INVENTION

1. Field of the Invention

The present invention relates to network relay devices and methods that the network relay devices execute for controlling relay of data frames received from external devices.

2. Description of the Background Art

Accompanying advances in information and communications technology (ICT), switching products known as intelligent switches have appeared. Such intelligent switches signify switching that is highly functional by comparison to general switches. Intelligent switches have a variety of functions including, for example, virtual local area network (VLAN) functions, security functions, and functions related to quality of service (QoS) (cf., for example, Japanese Laid-Open Patent Publication No. 2008-48252). Among the functions described above, improvement in security functions in particular that place a premium on threats within networks has been in demand in recent years.

Widely used in general as a security function that stresses the importance of threats within a network is a function called port-level security that restricts input of traffic, based on MAC addresses stored in external devices connected to intelligent-switch ports.

Meanwhile, there is a trade-off relationship between convenience and improvement in security, and the fact of the matter is pursuing one leads to sacrificing the other. For example, when port-level security functions are adopted in intelligent switches, it is necessary to know beforehand the MAC addresses of external devices that are to be connected to the ports.

Within the corporate workplace in recent years, however, employees using personal mobile terminals, smart phones, and the like for work, as well as guest users, such as fixed-term contract personnel and staff from affiliated and client companies, have been on the increase. A problem in these sorts of situations has been that putting strict security policies into operation for ports into which it is thus envisioned that indeterminate numbers of external devices will be connected compromises convenience.

What is more, this sort of problem has not been limited to intelligent switches, but on the whole has been a problem common to network relay devices with security functions.

Therefore, an object of the present invention is to make available network relay devices and data-frame relaying control methods for achieving both convenience and improvement in security.

### SUMMARY OF THE INVENTION

The present invention is directed toward a network relay device that relays frames received from external devices. In addition, in order to achieve the above described object, the network relay device of the present invention includes: a plurality of ports to which external devices connect, and configured pre-correlated with types of authentication to be conducted with respect to connected external devices, the types of authentication including a first authentication type and a second authentication type; an authentication process section for conducting, when an external device is connected to the network relay device, mutual authentication between the network relay device and the external device in accordance with a type of authentication that the port to which the external device is connected is configured for; and a relay process section for relaying, without authentication being conducted by the authentication process section, frames received through a port configured for the first authentication type as the type of authentication, and for relaying frames received through a port configured for the second authentication type as the type of authentication, if authentication by the authentication process section has succeeded.

Preferably, the network relay device further includes a security management section for monitoring frames received from an external device connected to the port configured for the first authentication type. Representatively, the security management section detects whether a computer virus is contained in frames received from an external device connected to a port configured for the first authentication type. Furthermore, when virtual network identifiers defining virtual subnetworks built by a virtual-subnetwork-constructing external device connected to the network relay device, are stored in the network relay device, and when the virtual-subnetwork-constructing external device is connected to the network relay device, the security management section transmits to the external device a virtual network identifier that differs depending on whether said external device is connected to a port configured for the first authentication type or a port configured for the second authentication type.

Furthermore, when a permission list for identifying, by the use of information included in frames received from an external device, frames that are relay-eligible is stored in the network relay device, and the relay process section may include an authentication information management section for changing content stipulated in the permission list in response to an external device's connection state. If an external device is connected to a port configured for the first authentication type, the authentication information management section preferably changes the content stipulated in the permission list so as to enable relay of frames received from the connected external device. If an external device is connected to a port configured for the second authentication type and if the mutual-authentication by the authentication process section has succeeded, the authentication information management section preferably changes the content stipulated in the permission list so as to enable relay of frames received from the connected external device. Furthermore, if the permission list has been changed, the authentication information management section preferably further transmits the content of the changed permission list to a separate network relay device connected to the network relay device.

The authentication process section preferably has functions both as an authentication client based on IEEE 802.1X and as an authentication server based on IEEE 802.1X. In addition, when a separate network relay device is connected to the network relay device and if the MAC address of the separate network relay device is pre-registered in the network relay device as a MAC address for which connection is to be permitted, the authentication process section may treat the separate network relay device as a partner with which mutual authentication has succeeded.

The above described configuration of the present invention allows to achieve both convenience and improvement in security in a network relay device.

It should be noted that the present invention can be attained in various modes. For example, the present invention can be attained in modes including network relay devices, methods for controlling network relay devices, network systems using network relay devices, and computer programs that achieve the functions of these methods or devices, and storage media having stored therein such computer programs.

The present invention is applicable to network systems and the like including a relay device and a wireless communication device; and is particularly useful when there is a need to improve security for wireless communications. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a schematic configuration of terminals and a network relay device according to a first embodiment of the present invention;

FIG. 2 is a diagram schematically representing the configuration of the network relay device according to the first embodiment;

FIG. 3 is a chart presenting one example of an authentication protocol list;

FIG. 4 is a chart presenting one example of a permission list;

FIG. 5 is a flowchart showing a procedural sequence of processes conducted by the network relay device according to the first embodiment of the present invention when a data frame is received;

FIG. 6 is a diagram for describing a specific Example 1 of a process conducted when a frame is received in the first embodiment;

FIG. 7 is a sequence diagram showing flow of a “No Auth” initial process (Step S32 in FIG. 5) conducted for the connections shown in FIG. 6;

FIG. 8 is a diagram for describing the specific Example 1 of a process conducted when a frame is received;

FIG. 9 is a sequence diagram showing the flow of an authentication process (Step S16 in FIG. 5) conducted for the connections shown in FIG. 8;

FIG. 10 is a diagram for describing a specific Example 2 of a process conducted when a frame is received in the first embodiment;

FIG. 11 is a chart presenting another example of a permission list;

FIG. 12 is a diagram schematically representing the configuration of the network relay device according to a second embodiment;

FIG. 13 is a chart presenting one example of VLAN-defining information;

FIG. 14 is a chart presenting one example of default VLAN information;

FIG. 15 is a diagram for describing a specific Example 1 of a process conducted when a frame is received in the second embodiment; and

FIG. 16 is a sequence diagram showing flow of a “No Auth” initial process (step S32 in FIG. 5) conducted for the connections shown in FIG. 15.

### DESCRIPTION OF THE PREFERRED EMBODIMENTS

Embodiments of the present invention will be described in the following with reference to the drawings.

### First Embodiment

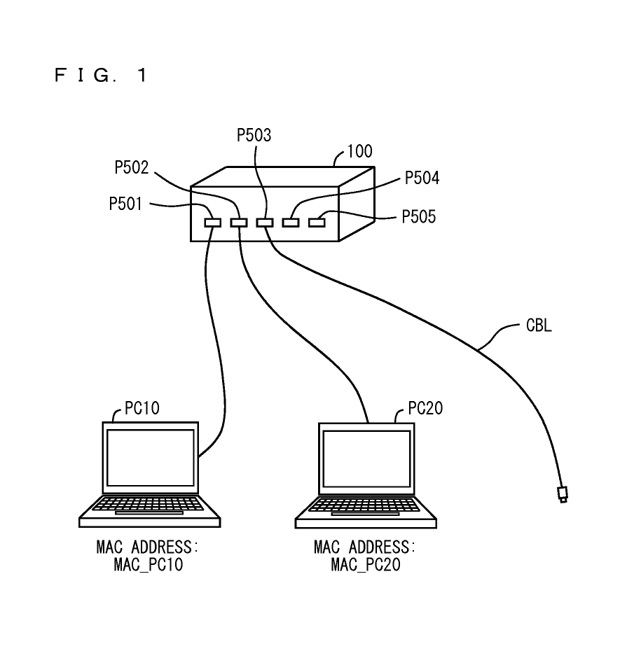

FIG. 1 shows a schematic configuration of a terminal PC10, a terminal PC20, and a network relay device 100 according to a first embodiment of the present invention. The network relay device 100 according to the first embodiment is a so-called Layer 2 switch, and functions to relay a frame by using a MAC (Media Access Control) address. Layer 2 corresponds to the second layer (data-link layer) of the OSI (Open Systems Interconnection) reference model. In the following, descriptions are provided by representing the network relay device 100 as a switch 100. An external device (e.g., a terminal or another switch) is connected to the switch 100 via five ports, P501 to P505.

In the example shown in FIG. 1, the terminal PC10, which is a personal computer or the like, is connected to the port P501 via a line. The MAC address of the terminal PC10 is MAC_PC10. The terminal PC20, which is a personal computer or the like, is connected to the port P502 via a line. The MAC address of the terminal PC20 is MAC_PC20. Only a LAN cable CBL is connected to the port P503. The port P503 is a LAN connection port for guest users such as, for example, employees under a fixed term contract, and staffs from affiliated companies and business partners; and unspecified number of terminals are envisioned to be connected to the port P503. It should be noted that, those that are unnecessary for the descriptions, such as other network devices, lines, terminals, and the internal configuration of the switch 100, are not diagrammatically represented in FIG. 1 for convenience. The same applies for all the figures describe later.

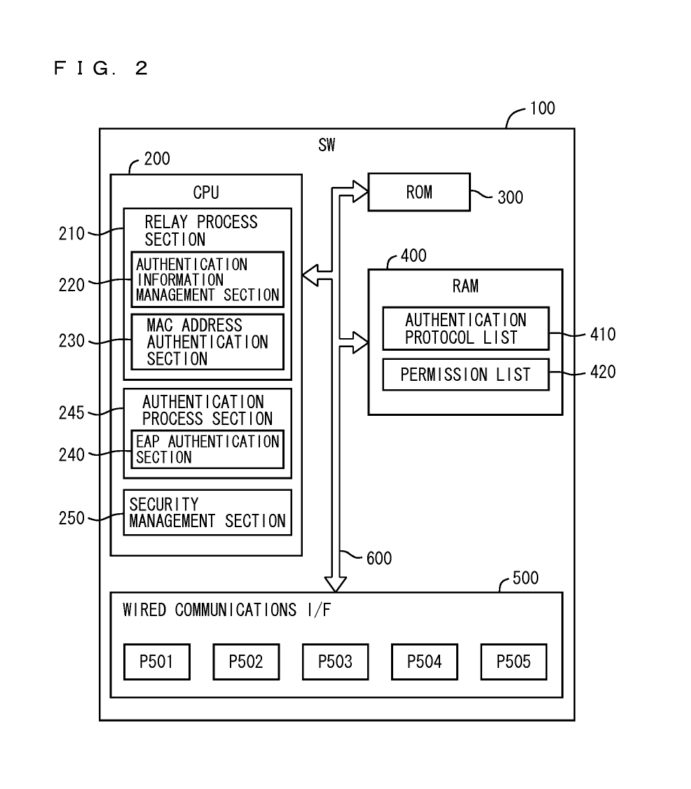

FIG. 2 schematically shows the configuration of the switch 100 according to the first embodiment. The switch 100 includes a CPU 200 (Central Processing Unit), a ROM (Read Only Memory) 300, a RAM (Random Access Memory) 400, and a wired communications interface (wired communications I/F) 500. All the components of the switch 100 are connected to each other via a bus 600.

The CPU 200 controls each section of the switch 100 by loading a computer program stored in the ROM 300 onto the RAM 400 and executing the computer program. In addition, the CPU 200 also functions as a relay process section 210, an authentication process section 245, and a security management section 250. The relay process section 210 includes an authentication information management section 220 and a MAC address authentication section 230, and functions to relay a frame received (described as a received frame in the following) via the wired communications interface 500. The main functions of the authentication information management section 220 include a function of updating a permission list 420 stored in the RAM 400 which is a storing section, and a function of exchanging the permission list 420 with another switch. The MAC address authentication section 230 functions as a determination process section for conducting a process of determining whether the received frame is eligible to be relayed. An EAP (Extensible Authentication Protocol) authentication section 240, which is included in the authentication process section 245, functions to conduct, when an external device (e.g., a terminal or another switch) is connected to the switch 100, authentication between the switch 100 and the external device in accordance with an authentication protocol that is determined in advance. The security management section 250 functions to manage received frames in order to maintain security. Details of each of these functional sections will be described later.

An authentication protocol list 410 and the permission list 420 are stored in the RAM 400. Details of each of these lists will be described later. The wired communications interface 500 is a connection opening for a LAN cable, and is used to connect to a local area network (LAN). The wired communications interface 500 includes the above described five ports, P501 to P505. In the present embodiment, the ports P501 to P504 are ports used for connecting with external devices (e.g., personal computers, mobile terminals, and the like) other than switches. The port P505 is a port used for connecting to other switches in cascade.

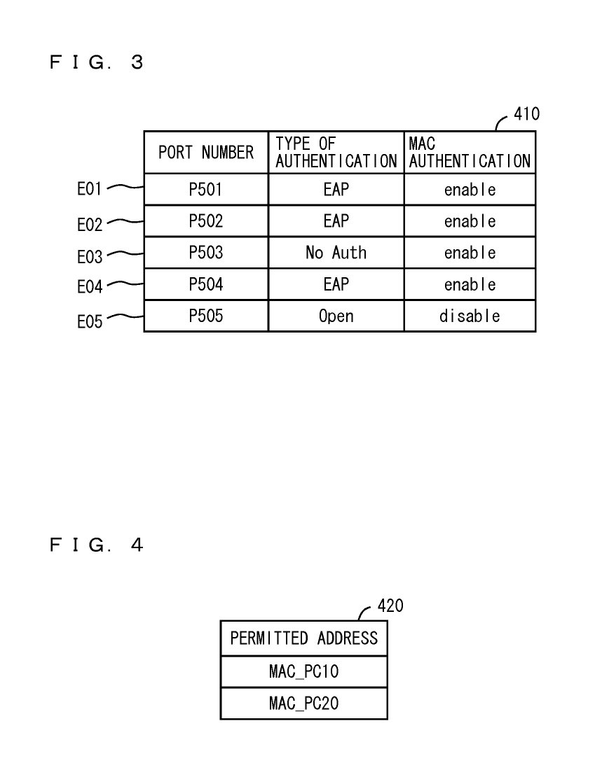

FIG. 3 shows one example of the authentication protocol list 410. The authentication protocol list 410 includes a port number field, an authentication-type field, and a MAC authentication field. Identifiers of all the ports included in the switch 100 are stored as entries of the port number field. The identifiers in the present embodiment are “P501” to “P505.”

Stored in the authentication-type field is the type of authentication predetermined for each of the ports stored in the port number field. The type of authentication refers to the type of authentication that is to be conducted, by the EAP authentication section 240, on the external device when the external device is connected to a port. The types of authentication used in the present embodiment include three types, “EAP,” “No Auth,” and “Open.” No Auth, which is a first authentication type, means an authentication is unnecessary for the external device connected to the switch 100 (in other words, the authentication of the external device will be skipped). EAP, which is a second authentication type, means an authentication is necessary for the external device connected to the switch 100. The authentication protocol that is actually used when the type of authentication is EAP is stored inside the RAM 400 in advance. In the present embodiment, the authentication is conducted by using EAP-MD5 (extensible authentication protocol-message digest version 5) of IEEE (Institute of Electrical and Electronics Engineers) 802.1X. A user may be given an ability to configure the authentication protocol stored in the RAM 400. Open means there will be no authentication conducted on the external device connected to the switch 100. The difference between No Auth and Open will be described later.

Stored in the MAC authentication field are setting values to “enable” or “disable” a MAC address authentication; and the setting values are predetermined for each of the ports whose identifiers are stored in the port number field.

For example, in FIG. 3, it is specified that when the external device is connected to the port P501 which is identified by an identifier P501, an authentication based on EAP, i.e., an authentication in accordance with the EAP-MD5 authentication protocol, will be conducted. In addition, it is specified that a MAC address authentication will be conducted on a frame received through the port P501 (entry E01). It is also specified that an authentication will not be conducted (an authentication will be skipped) when the external device is connected to the port P503 identified by an identifier P503. In addition, it is specified that a MAC address authentication is conducted on a frame received through the port P503 (entry E03). It is also specified that an authentication will not be conducted when the external device is connected to the port P505 identified by an identifier P505. In addition, it is specified that a MAC address authentication will not be conducted on a frame received through the port P505 (entry E05).

More specifically, the port P503 set for No Auth and the port P505 set for Open have a common feature in that an authentication will not be conducted on the external device connected to respective ports. However, the port P503 and the port P505 differ in the following points.

On a frame received through the port configured for No Auth as the type of authentication, a MAC address authentication is conducted and a later described security management process is conducted.

On a frame received through the port configured for Open as the type of authentication, a MAC address authentication will not be conducted and a security management process will not be conducted.

In order to correctly relay a received frame, the MAC address authentication is set as “disable” for a port whose type of authentication is set as “Open” as in entry E05. Therefore, for a port whose type of authentication is set as “Open,” the switch 100 will not conduct an authentication when an external device has been connected and will not conduct a MAC address authentication on a received frame. As a result, a port whose type of authentication is set as “Open” may become a security hole.

FIG. 4 shows one example of the permission list 420. The permission list 420 is a list used when conducting a MAC address authentication. A transmission source MAC address is a MAC address of a device that has transmitted a frame to the switch 100. Stored in the permission list 420 as permitted addresses are transmission source MAC addresses from which frames that will be permitted by the relay process section 210 of the switch 100 for relaying are received. Thus, the permission list 420 is configured such that a received frame eligible to be relayed can be identified by using the information included in the received frame.

For example, in FIG. 4, if the transmission source MAC address included in a header of a received frame is either “MAC_PC10” or “MAC_PC20”, relaying of the received frame will be permitted by the relay process section 210.

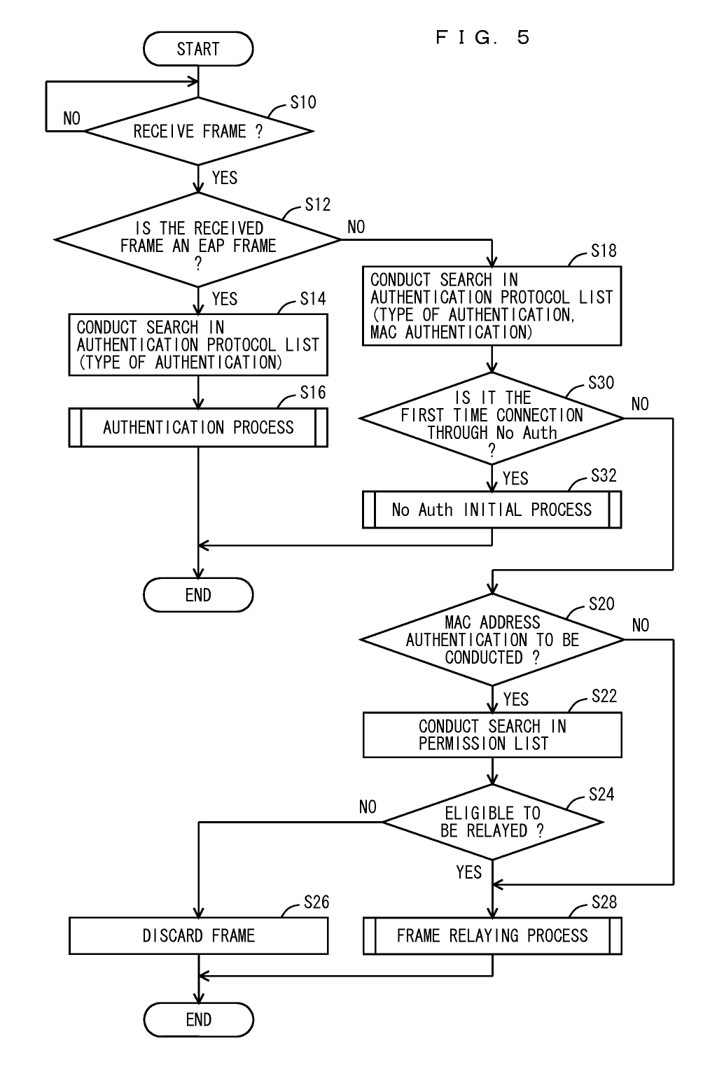

Next, a frame reception process, which includes process steps conducted by the switch 100 of the above described configuration when a frame is received, will be described. FIG. 5 is a flowchart showing process steps of the frame reception process conducted by the network relay device (switch) 100 according to the first embodiment of the present invention.

First, the relay process section 210 determines whether a frame has been received through any one of the ports P501 to P505 (step S10). When a frame is received (step S10: YES), the relay process section 210 judges whether or not the received frame is an EAP frame (step S12). Specifically, for example, when the type of the received frame, which is determined from an EtherType included in the header of the received frame, is EAPOL (extensible authentication protocol over LAN); the relay process section 210 can judge that an EAP frame has been received.

When the received frame is judged as an EAP frame (step S12: YES), the EAP authentication section 240 conducts a search in the authentication-type field of the authentication protocol list 410 (step S14). Specifically, the EAP authentication section 240 refers to the authentication protocol list 410, and acquires the value in the authentication-type field from the entry that has, in the port number field, the identifier of the port through which the frame has been received. The EAP authentication section 240 conducts an authentication process that is necessary, and then ends the process (step S16). Details of the authentication process will be described later.

On the other hand, when the received frame is judged as not being an EAP frame (step S12: NO), the EAP authentication section 240 conducts a search in the MAC authentication field and in the authentication-type field of the authentication protocol list 410 (step S18). Specifically, the EAP authentication section 240 refers to the authentication protocol list 410, and acquires the value in the MAC authentication field and the value in the authentication-type field from the entry that has, in the port number field, the identifier of the port through which the frame has been received.

Next, the EAP authentication section 240 judges whether the connection is conducted for the first time with the external device through the No Auth port (step S30). Specifically, the EAP authentication section 240 judges whether the value in the authentication-type field acquired at step S18 is “No Auth,” and whether the transmission source MAC address included in the header of the received frame matches any one of the MAC addresses stored in the permission list 420. When the value in the authentication-type field is No Auth, and when the transmission source MAC address does not match a MAC address stored in the permission list 420, the EAP authentication section 240 judges that the received frame is the first frame received from the external device connected to the No Auth port (step S30: YES). As a result of this judgment, the EAP authentication section 240 conducts a No Auth initial process (step S32), and then ends the process. Details of the No Auth initial process will be described later.

On the other hand, if the value in the authentication-type field is not No Auth, or if the transmission source MAC address matches any one of the MAC addresses stored in the permission list 420 even when the value in the authentication-type field is No Auth; the EAP authentication section 240 judges that the received frame is a frame received from an external device connected to a port other than the No Auth port or is a frame received at least the second time from an external device connected to the No Auth port (step S30: NO). As a result of this judgment, the MAC address authentication section 230 further judges whether to conduct the MAC address authentication (step S20). Specifically, the MAC address authentication section 230 conducts the MAC address authentication if the value in the MAC authentication field acquired at step S18 is “enable,” and does not conduct the MAC address authentication if the value in the MAC authentication field is “disable.” When it is judged not to conduct the MAC address authentication (step S20: NO), the MAC address authentication section 230 conducts a frame relaying process (step S28).

When it is judged to conduct the MAC address authentication (step S20: YES), the MAC address authentication section 230 refers to the permission list 420 (step S22), and judges whether or not the received frame is eligible to be relayed (step S24). Specifically, the MAC address authentication section 230 judges whether or not the transmission source MAC address included in the header of the received frame matches any one of the MAC addresses stored in the permission list 420. When there are no matches in the MAC addresses and when it is judged that the received frame is not eligible to be relayed (step S24: NO), the MAC address authentication section 230 discards the received frame (step S26), and ends the process. After discarding the received frame, the MAC address authentication section 230 may notify the source terminal from which the discarded frame has been transmitted about the discarding of the frame.

On the other hand, when it is judged not to conduct the MAC address authentication at step S20 described above (step S20: NO), and when there is a match in the MAC addresses and it is judged that the received frame is eligible to be relayed at step S24 described above (step S24: YES), the MAC address authentication section 230 conducts a frame relaying process (step S28). In this frame relaying process, the relay process section 210 refers to a MAC address table which is not shown, and conducts forwarding (a frame relaying operation conducted when a destination MAC address is in the MAC address table) or flooding (an operation conducted when the destination MAC address is not in the MAC address table), and then ends the process. As described above, the MAC address authentication section 230 of the relay process section 210 determines whether the received frame is eligible to be relayed based on the permission list 420.

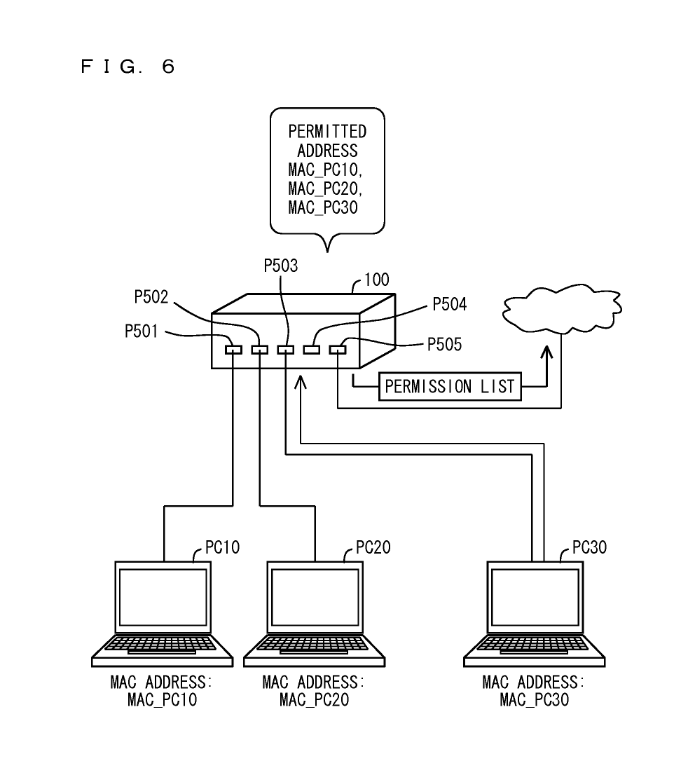

A specific example of a process conducted by the switch 100 when a frame is received will be described in the following by further referring to FIG. 6 to FIG. 11.

### 1. When a Terminal is Connected as a New External Device

### Specific Example 1

In a specific Example 1, a case will be described where a terminal is connected to the switch 100 as a new external device.

1-1. No Auth Initial Process

FIG. 6 shows a situation in which the No Auth initial process (step S32 in FIG. 5) is conducted when a new external device (terminal PC30) is connected to the switch 100. The configuration of the switch 100 is identical to that described in FIG. 1. Described in FIG. 6 is a case where, at the state shown in FIG. 1, the terminal PC30 (MAC address: MAC_PC30) is connected to the port P503 which belongs to the switch 100 and to which No Auth is set as the type of authentication.

When the newly connected terminal PC30 transmits a frame to the switch 100 (or to another terminal connected to the switch 100), the switch 100 detects the frame received from the terminal PC30 (step S10: YES). Since the received frame which has been detected is not an EAP frame (step S12: NO), the EAP authentication section 240 acquires, from the authentication protocol list 410, the “No Auth” value in the authentication-type field and the “enable” value in the MAC authentication field for the port P503 through which the frame has been received (step S18). Since the value in the authentication-type field is “No Auth” and the transmission source MAC address of MAC_PC30 is not stored in the permission list 420, the EAP authentication section 240 judges that the received frame is the first frame received from the external device connected to the No Auth port (step S30: YES). As a result, the EAP authentication section 240 conducts the No Auth initial process (step S32).

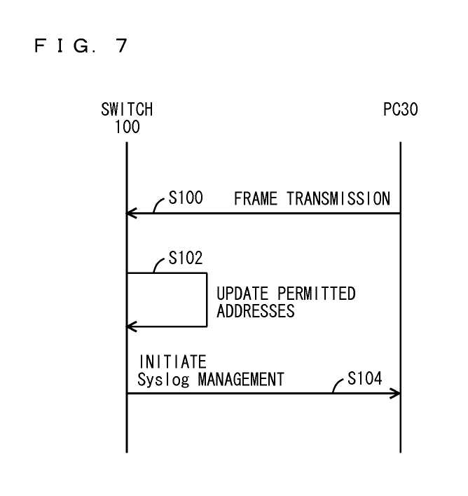

FIG. 7 is a sequence diagram showing a flow of a No Auth initial process (step S32 in FIG. 5) in the first embodiment. First, the switch 100 receives a frame transmitted from the terminal PC30 (step S100). The authentication information management section 220 of the switch 100 adds, to the permission list 420, the transmission source MAC address included in the header of the frame received from the terminal PC30, and updates the permission list 420 (step S102).

Then, the security management section 250 of the switch 100 initiates a “Syslog” management for the terminal PC30 (step S104). Specifically, the security management section 250 acquires the kernel of the terminal PC30 and logs outputted from various daemons, applications, and the like, and stores those in the RAM 400 and other storage media (e.g., flash ROM, hard disk, and the like which are not shown) of the switch 100. In addition, the security management section 250 monitors the logs acquired from the terminal PC30, and, in case some sort of malfunction is detected, the security management section 250 may notify an administrator of the switch 100 about the detected malfunction. Various methods can be adopted as the method of notification, including turning on alarm-lights, transmitting an E-mail to a predetermined address, and the like. The Syslog management for the terminal PC30 is preferably conducted continuously until the connection with the terminal PC30 is disconnected.

It should be noted that the above described Syslog management (step S104) is merely one example of the security management conducted by the security management section 250; and various management method as described in the following can be used instead of the Syslog management, or in addition to the Syslog management.

For example, the security management section 250 can conduct a virus scan in order to detect whether a computer virus is contained in the frame received from the external device connected to the port which type of authentication is No Auth. When a computer virus is detected in the received frame, the security management section 250 can discard the received frame without relaying the received frame. Furthermore, when discarding the received frame, the security management section 250 may notify the administrator of the switch 100 about the detection of the computer virus.

In addition, for example, a MAC address of an external device connected to the port which type of authentication is No Auth may be stored in the RAM 400 or another storage medium (for example, a flash ROM, a hard disk, and the like which are not shown) of the switch 100, and the security management section 250 may refer to the stored MAC address when a problem occurs in the network that includes the switch 100. Furthermore, for example, when the No Auth initial process is conducted, the security management section 250 may notify, by using E-mail or the like, the administrator of the switch 100 about information (e.g., the MAC address, user name, password, and the like of the terminal PC30) of the external device that has been newly added to the permission list 420.

In addition to the MAC addresses (MAC_PC10 and MAC_PC20) of the two terminals (PC10 and PC20) that are already connected to the switch 100, the MAC address (MAC_PC30) of the terminal PC30 that has been newly connected to the switch 100 is added to the permission list 420 stored inside the switch 100 through the above described No Auth initial process (FIG. 6).

Described in the following by using FIG. 6 is a case where a frame is transmitted from the terminal PC30 to the terminal PC20 after the No Auth initial process is conducted. The switch 100 which has received the frame from the terminal PC30 (step S10) judges that the received frame is not an EAP frame (step S12: NO). The EAP authentication section 240 of the switch 100 refers to the authentication protocol list 410, and acquires the “No Auth” value in the authentication-type field and the “enable” value in the MAC authentication field of the port P503 through which the frame has been received (step S18). Then, since the value in the authentication-type field acquired at step S18 is “No Auth” and the transmission source MAC address of MAC_PC30 matches a MAC address stored in the permission list 420, the EAP authentication section 240 judges that the received frame is a frame received at least the second time from the terminal connected to the No Auth port (step S30: NO).

Next, the MAC address authentication section 230 of the switch 100 judges that the MAC address authentication should be conducted, since the value in the MAC authentication field acquired at step S18 is “enable” (step S20: YES). Since the transmission source MAC address of MAC_PC30 matches a MAC address stored in the permission list 420 as a result of conducting a search in the permission list 420 (step S22), the MAC address authentication section 230 judges that the received frame is eligible to be relayed (step S24: YES). In accordance with this judgment, the relay process section 210 of the switch 100 conducts the frame relaying process (step S28). As a result, the frame received by the switch 100 from the port P503 is transmitted from the port P502 of the switch 100 toward the terminal PC20.

For example, when the switch 100 is connected to still another switch, the switch 100 may transmit, to the still another switch, the frame including the permitted addresses stored in the updated permission list 420. As a result of spreading the updated permitted addresses to other switches connected to a switch, the content of the permission list that is to be used in the MAC address authentication (i.e., MAC addresses of external devices that should be permitted to have frames relayed thereto) can be exchanged between switches, and thereby a further improvement in convenience can be achieved. The permitted addresses may be spread to switches within a range of a single segment demarked by a router. The permitted addresses may be spread to the router itself. Then, the MAC addresses can be managed also by the router.

As described above, when a terminal which is an external device is connected to a port configured for “No Auth” as the type of authentication, the switch 100 skips conducting an authentication for the connected terminal, and conducts the process to permit relay a frame from the terminal (i.e., No Auth initial process). Therefore, the port configured for “No Auth” as the type of authentication can be provided as a port that enables communication by merely having a terminal connected thereto without the need for any special processes on the terminal side (e.g., inputting a user name and password, and the like). Therefore, for example, the administrator of the switch 100 can improve convenience of the switch 100, by presetting the type of authentication to “No Auth” for a port having the possibility being connected to unspecified number of terminals.

In addition, the security management section 250 conducts security management through various methods as described in FIG. 7 for the port configured for “No Auth” as the type of authentication. As a result, the switch 100 can achieve improvement in security while ensuring convenience as described above.

1-2. Authentication Process

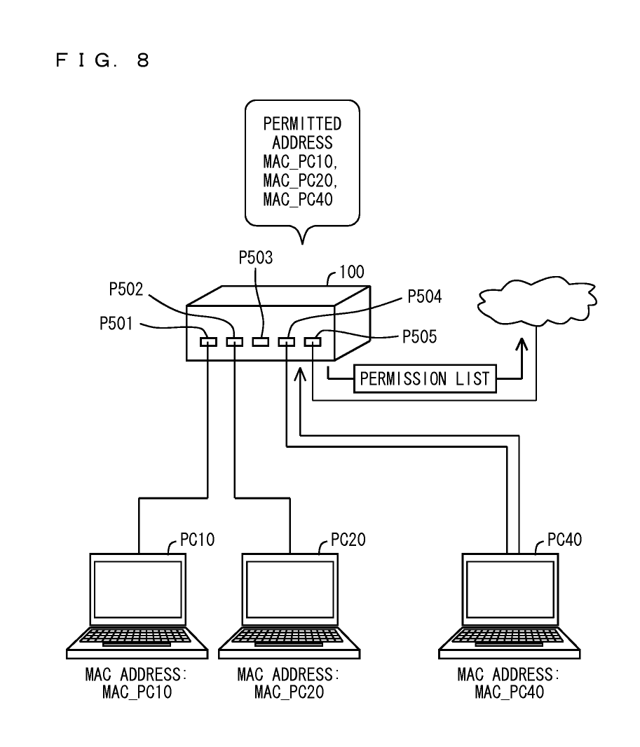

FIG. 8 shows a situation in which the authentication process (step S16 in FIG. 5) is conducted when a new external device (terminal PC40) is connected to the switch 100. The configuration of the switch 100 is identical to that described in FIG. 1. Described in FIG. 8 is a case where, at the state shown in FIG. 1, the terminal PC40 (MAC address: MAC_PC40) is connected to the port P504 which belongs to the switch 100 and to which EAP is set as the type of authentication.

When the newly connected terminal PC40 transmits a frame to the switch 100 (or to another terminal connected to the switch 100), the switch 100 detects the frame received from the terminal PC40 (step S10: YES). Since the frame received from the terminal PC40 is an EAPOL-start frame for requesting an authentication to start (step S12: YES), the EAP authentication section 240 refers to the authentication protocol list 410 and judges that the type of authentication is EAP (step S14), and conducts a predetermined authentication process (step S16).

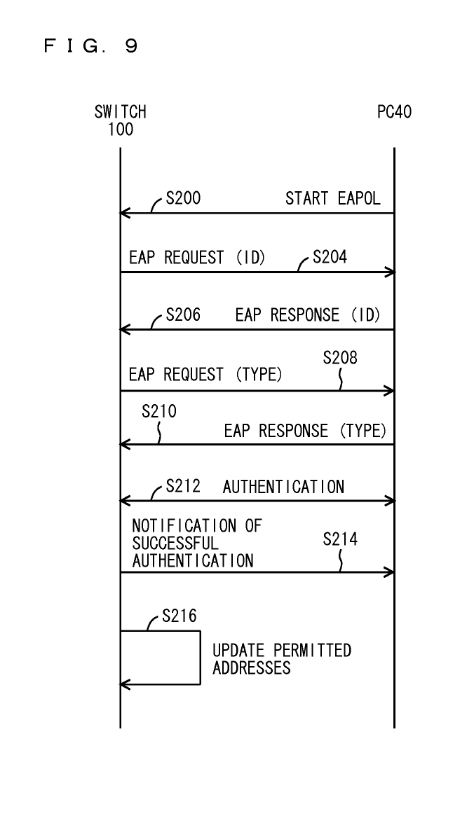

FIG. 9 is a sequence diagram showing a flow of the authentication process in the first embodiment (step S16 in FIG. 5). First, an EAPOL-start frame (EAP over LAN-Start) for requesting an authentication to start is transmitted from the terminal PC40 acting as a supplicant to the switch 100 acting as an authenticator (step S200). The EAP authentication section 240 of the switch 100, which has received the EAPOL-start frame, transmits, to the terminal PC40, an EAP request frame requesting an ID of the supplicant (step S204). The terminal PC40 which has received the request frame transmits, to the switch 100, an EAP response frame including the ID of the supplicant (step S206). Next, the EAP authentication section 240 of the switch 100 transmits, to the terminal PC40, the EAP request frame notifying the type of EAP that is to be used for the authentication (EAP-MD5 in the present embodiment) (step S208). The terminal PC40 which has received the request frame transmits, to the switch 100, the EAP response frame including an identifier of the type of EAP that is to be used for the authentication (step S210).

Then, an authentication conforming to the authentication protocol announced at step S210 is conducted between the switch 100 and the terminal PC40 (step S212). If the authentication has succeeded, the EAP authentication section 240 of the switch 100 transmits, to the terminal PC40, an EAP frame notifying the terminal that the authentication has succeeded (step S214). It should be noted that each of the frames described above has a configuration conforming to the format predetermined by the rules of EAP, and the values of IDs, types, and the like are transmitted and received as data stored in specified positions within the frames. After the success of the authentication, the authentication information management section 220 of the switch 100 adds, to the permission list 420, the transmission source MAC address included in the header of the frame received from the terminal PC40, and updates the permission list 420 (step S216).

If the authentication of the external device has succeeded through the above described authentication process, the MAC address (MAC_PC40) of the terminal PC40 which has been newly connected to the switch 100 is stored inside the permission list 420 in the switch 100, in addition to the MAC addresses (MAC_PC10 and MAC_PC20) of the two terminals (PC10 and PC20) that are already connected to the switch 100 (FIG. 8). As a result, similar to that described in FIG. 6, after the authentication process, a frame transmitted and received between the switch 100 and the terminal PC40 is relayed by the relay process section 210. Therefore, the port configured for “EAP” as the type of authentication can be provided as a port capable of conducting communications after the successful authentication process.

### 2. When Another Switch is Connected as a New External Device

### Specific Example 2

In a specific Example 2, a case will be described where another switch is connected to a switch 100 as a new external device.

2-1. No Auth Initial Process

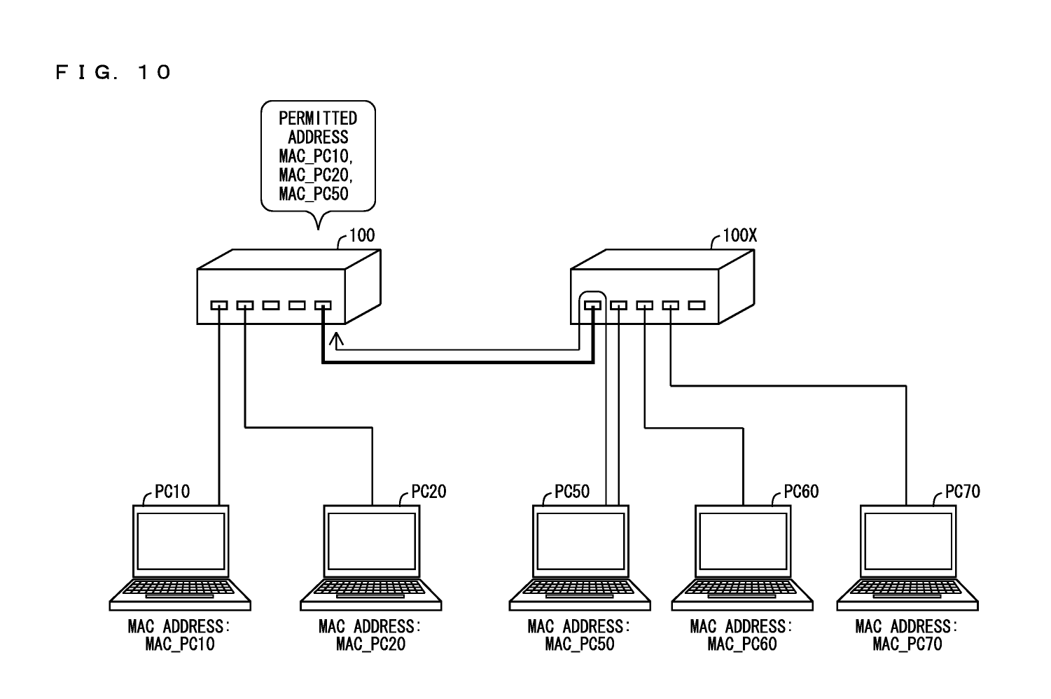

FIG. 10 shows a situation in which the No Auth initial process (step S32 in FIG. 5) is conducted when a new external device (another switch 100X) is connected to the switch 100. The configuration of the switch 100 is similar to that of the switch 100 shown in FIG. 1, except that the content stored in a authentication protocol list 410 is content shown in FIG. 11.

FIG. 11 shows an example of the authentication protocol list 410 included in the switch 100 of the specific Example 2. The authentication protocol list 410 shown in FIG. 11 differs from the authentication protocol list 410 shown in FIG. 3, in that it is specified in entry E05 that an authentication will not be conducted (the authentication will be skipped) when an external device is connected to the port P505 (i.e., the port for cascade connection) and that a MAC address authentication will be conducted on a frame received through the port P505.

In addition, the configuration of the other switch 100X is similar to that of the switch 100 shown in FIG. 1, except that the port P501 is configured as a port for cascade connection. With regard to the ports of the other switch 100X, the port P501 has the port P505 of the switch 100 connected thereto, the port P502 has a terminal PC50 connected thereto, the port P503 has a terminal PC60 connected thereto, the port P504 has a terminal PC70 connected thereto, and all connections are formed via lines. In addition, the MAC address of the terminal PC50 is MAC_PC50, the MAC address of the terminal PC60 is MAC_PC60, and the MAC address of the terminal PC70 is MAC_PC70. Descriptions will be omitted for the authentication protocol list 410, the permission list 420, and the like which are stored inside the other switch 100X.

Described in FIG. 10 is a case where, at the state shown in FIG. 1, the other switch 100X is connected to a cascade connection port, the port P505, to which No Auth is set as the type of authentication and which belongs to the switch 100, and where a frame is transmitted from the terminal PC50 to the terminal PC20. It should be noted that processes such as relaying of a frame in the other switch 100X is basically identical to that in the switch 100, and thereby descriptions thereof are omitted.

When the terminal PC50 transmits a frame to the terminal PC20, the switch 100 detects the received frame that is transmitted from the terminal PC50 via the other switch 100×(step S10: YES). Since the received frame which has been detected is not an EAP frame (step S12: NO), the EAP authentication section 240 of the switch 100 acquires, from the authentication protocol list 410, the “No Auth” value in the authentication-type field and the “enable” value in the MAC authentication field for the port P505 through which the frame has been received (step S18). Since the value in the authentication-type field is “No Auth” and the transmission source MAC address of MAC_PC50 is not stored in the permission list 420, the EAP authentication section 240 of the switch 100 judges that the received frame is the first frame received from the external device connected to the No Auth port (step S30: YES). As a result, the EAP authentication section 240 of the switch 100 conducts the No Auth initial process (step S32). The No Auth initial process is similar to that described in FIG. 7.

In addition to the MAC addresses (MAC_PC10 and MAC_PC20) of the two terminals (PC10 and PC20) that have been directly connected to the switch 100, the MAC address (MAC_PC50) of the terminal PC50 which has been newly connected to the switch 100 via the other switch 100X is added to the permission list 420 stored inside the switch 100 by the above described No Auth initial process (FIG. 10). In the switch 100, after having the MAC address of the terminal PC50 added to the permission list 420, a frame transmitted/received to/from the newly connected terminal PC50 is also relayed without being discarded in a manner similar to the case described in FIG. 6. Furthermore, the terminals PC60 and PC70 connected to the other switch 100X are similar to the terminal PC50 described in FIG. 10. Therefore, a frame transmitted and received among each of the terminals can be relayed by having the switch 100 conduct the No Auth initial process when the first frame is received from each of the terminals.

Similar to the case described in FIG. 6, for example, when the switch 100 is connected to still another switch, the switch 100 may transmit, to the still another switch, the frame including the permitted address stored in the updated permission list 420.

Even when another switch is connected as an external device, by having the port for cascade connection (port P505) set for “No Auth” as the type of authentication as described above, an advantageous effect similar to when a terminal is connected as an external device can be obtained since a similar process is conducted. Therefore, the switch 100 can attain the various security managements described in FIG. 7 also against accesses from other switches and external devices connect to other switches that are connected via the port for cascade connection.

2-2. Authentication Process

Even when another switch is connected as an external device to the port configured for “EAP” as the type of authentication, an advantageous effect similar to when a terminal is connected as an external device can be obtained since a similar process (specifically, the process described in FIG. 8 and FIG. 9) is conducted. Detailed descriptions of this will be omitted.

Although the switch 100 functions as an authentication server (authenticator) based on IEEE 802.1X when an authentication process is to be conducted when the other switch 100X is connected to the switch 100, the switch 100 may function as an authentication client (supplicant) based on IEEE 802.1X. For example, when an EAPOL-start frame has not been received from a connection partner device for a certain period of time after detecting a linkup, the switch 100 may transmit an EAPOL-start frame to the connection partner device. In such a case, the switch 100 functions as an authentication client and the connection partner device functions as an authentication server. Thus, the EAP authentication section 240 may have functions of both an authentication client based on IEEE 802.1X and an authentication server based on IEEE 802.1X. As a result, a highly flexible authentication can be attained since the switch 100 can behave as an authentication client and as an authentication server with respect to the other switch 100X.

As described above, with the switch 100 according to the first embodiment, a frame received from the connected external device (e.g., terminals and other switches) is relayed if the type of authentication that the port which received the frame is configured for is the first authentication type (No Auth), and a frame received from the external device is relayed if the type of authentication that the port which received the frame is configured for is the second authentication type (EAP) and if the authentication of the connected external device has succeeded. As a result, the switch 100 according to the first embodiment can achieve both convenience and improvement in security.

Furthermore, the switch 100 according to the first embodiment may include the security management section 250 for monitoring a frame received from the external device connected to the port configured for the first authentication type (No Auth), and may detect whether the monitored received-frame includes a computer virus. Therefore, the switch 100 according to the first embodiment can achieve a further improvement in security.

In addition, the switch 100 according to the first embodiment changes the content stipulated in the permission list 420, so as to allow relaying of a frame received from the external device connected to the port configured for the first authentication type (No Auth), and so as to allow relaying of a frame received from the external device that is connected to the port configured for the second authentication type (EAP) and with which the authentication has succeeded. As a result the switch 100 according to the first embodiment can achieve both convenience and improvement in security. Furthermore, since the switch 100 according to the first embodiment transmits the content of the updated permission list 420 to other switches that are connected, a further improvement in convenience can be achieved.

### Second Embodiment

Described in a second embodiment of the present invention is a configuration capable of further conducting a security management using a VLAN (Virtual LAN), which is a virtual network, in the network relay device (switch) 100 of the first embodiment. In the following, descriptions of the second embodiment are provided only for those having a configuration or operation that is different from the first embodiment. It should be noted that, in the figures used for the second embodiment, components identical to those in the first embodiment are given identical reference characters, and detailed descriptions of those are omitted.

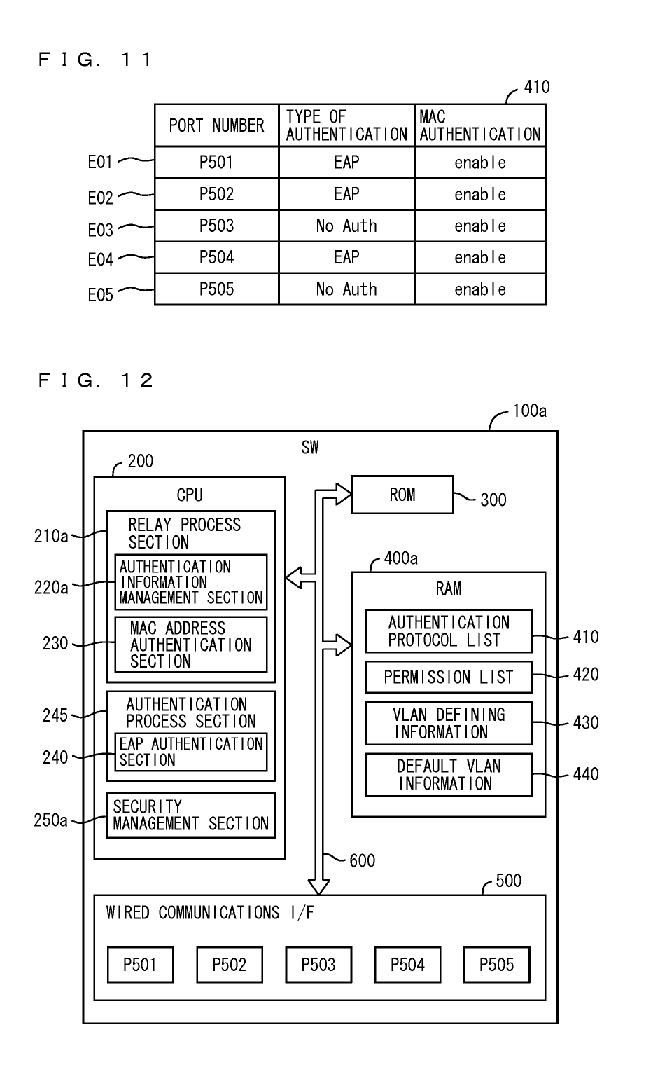

FIG. 12 schematically shows a configuration of a network relay device (switch) 100a according to the second embodiment of the present invention. The switch 100a of the second embodiment differs from the switch 100 of the first embodiment shown in FIG. 2 with regard to a relay process section 210a, an authentication information management section 220a, a security management section 250a, and a RAM 400a.

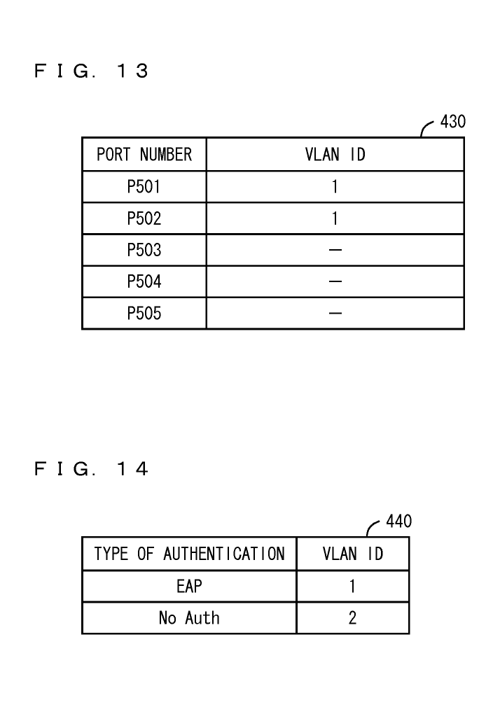

In addition to the authentication protocol list 410 and the permission list 420 described in the first embodiment, VLAN defining information 430 and default VLAN information 440 are stored in the RAM 400a. FIG. 13 shows one example of the VLAN defining information 430. The VLAN defining information 430 is information that defines a virtually built subnetwork (hereinafter, referred to as a virtual network) other than a physical mode of connection, and includes the port number field and a VLAN ID field. Identifiers of all the ports included in the switch 100a are stored as entries of the port number field. Port identifiers in the present embodiment are “P501” to “P505.” Stored in the VLAN ID field is an identifier (VLAN ID) of the virtual network, and the identifier is pre-assigned to a port stored in the port number field. The VLAN identifier in the present embodiment is “1.”

For example, in FIG. 13, an external device connected to the port P501 identified by the port identifier P501 (i.e., the terminal PC10 shown in FIG. 1) is specified as belonging to a virtual network identified by a VLAN identifier “1.” Similarly, an external device connected to the port P502 identified by the port identifier P502 (i.e., the terminal PC20 shown in FIG. 1) is specified as belonging to a virtual network identified by a VLAN identifier “1.”

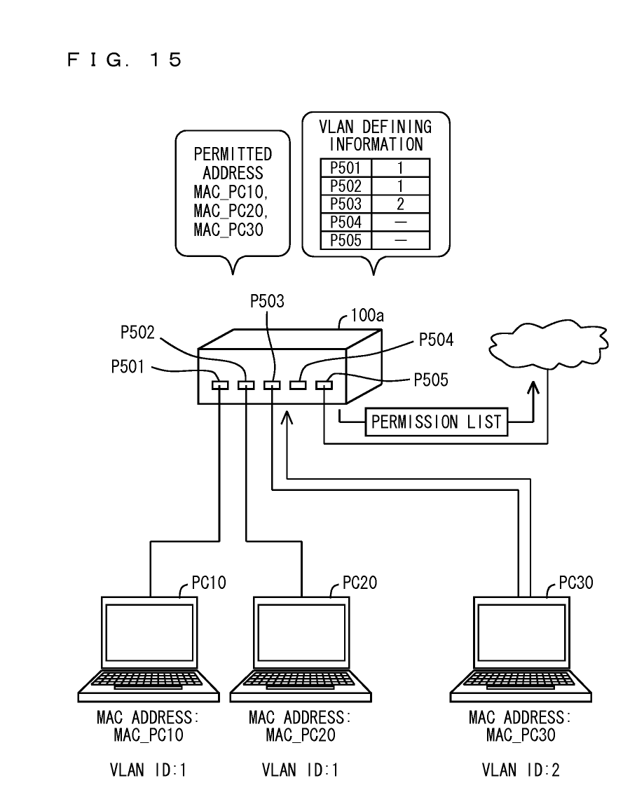

FIG. 14 shows one example of the default VLAN information 440. The default VLAN information 440 includes the authentication-type field and the VLAN ID field. Stored in the authentication-type field are the types of authentication (EAP, No Auth, and Open) assigned to respective ports in the authentication protocol list 410. It should be noted that the types of authentication stored in the authentication-type field may be all or one part of the types of authentication assigned to respective ports in the authentication protocol list 410. For example, in FIG. 14, the type of authentication “Open” is omitted. A predetermined VLAN identifier is stored in the VLAN ID field for each of the types of authentication stored in the authentication-type field. Therefore, the default VLAN information 440 is a table for storing a type of authentication and a corresponding VLAN identifier that should be assigned to an external device connected to a port at which the type of authentication is used.

For example, in FIG. 14, it is specified that a VLAN identifier of “1” is assigned to an external device connected to the port configured for EAP as the type of authentication. In addition, it is specified that a VLAN identifier of “2” is assigned to an external device connected to the port configured for No Auth as the type of authentication. Therefore, in the present embodiment, it is specified that different VLAN identifiers are assigned to an external device connected to the port configured for EAP as the type authentication and to an external device connected to the port configured for No Auth as the type of authentication.

A frame reception process conducted by the switch 100a having the above described configuration is similar to that described in FIG. 5. However, the relay process section 210a can build, in accordance with the VLAN defining information 430, a virtual network (VLAN) for an external device connected to the switch 100a directly or indirectly via another switch and the like. More specifically, with regard to the frame relaying process (step S28 in FIG. 5), by referring to the VLAN defining information 430, the relay process section 210a assumes that ports assigned with VLAN identifiers of different virtual networks belong to different virtual networks, and conducts a frame relaying process. Therefore, according to the VLAN defining information 430 shown in FIG. 13, the terminal PC10 and the terminal PC20 in FIG. 1 are given identical VLAN identifiers, and thereby are treated by the relay process section 210a as belonging to an identical virtual network. As a result, the switch 100a relays frames between the terminal PC10 and the terminal PC20.

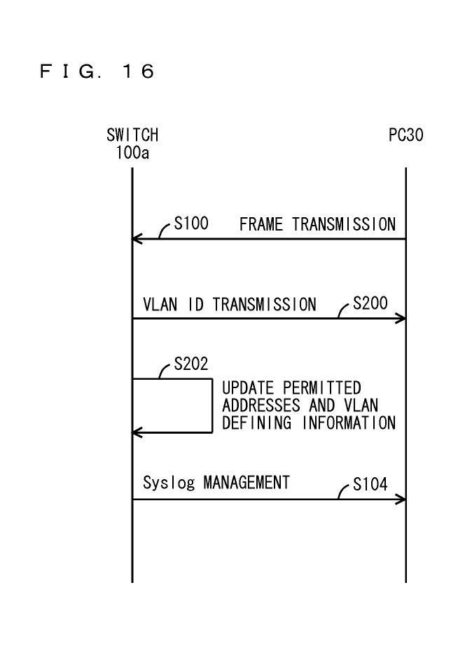

A specific example of a process conducted by the switch 100a when a frame is received will be described in the following by further referring to FIG. 15 and FIG. 16.

### 1. When a Terminal is Connected as a New External Device

### Specific Example 1

In a specific Example 1, a case will be described where a terminal is connected to the switch 100a as a new external device.

1-1. No Auth Initial Process

FIG. 15 shows a situation in which the No Auth initial process (step S32 in FIG. 5) is conducted when a new external device (terminal PC30) is connected to the switch 100a. The configuration of the switch 100a is that described in FIG. 1 and FIG. 12. Described in FIG. 15, is a case where, at the state shown in FIG. 1 and FIG. 12, the terminal PC30 (MAC address: MAC_PC30) is connected to the port P503 which belongs to the switch 100a and to which No Auth is set as the type of authentication.

When the newly connected terminal PC30 transmits a frame to the switch 100a (or to another terminal connected to the switch 100a), the EAP authentication section 240 of the switch 100a conducts the No Auth initial process through a process similar to that described in FIG. 6.

FIG. 16 is a sequence diagram showing a flow of the No Auth initial process (step S32 in FIG. 5) in the second embodiment. First, the switch 100a receives a frame transmitted from the terminal PC30 (step S100). After receiving the frame from the terminal PC30, the security management section 250a of the switch 100a transmits, to the terminal PC30, a VLAN identifier that should belong to the terminal PC30 (step S200). More specifically, the security management section 250a refers to the default VLAN information 440, and acquires the value “2” of the VLAN ID field in an entry having “No Auth” as the value in the authentication-type field. The security management section 250a transmits the acquired value “2” of the VLAN ID field to the terminal PC30.

Then, The authentication information management section 220a of the switch 100a updates the permitted addresses and the VLAN defining information (step S202). More specifically, the authentication information management section 220a adds, to the permission list 420, the transmission source MAC address included in the header of the frame received form the terminal PC30, and updates the permission list 420. Additionally, in the VLAN defining information 430, the authentication information management section 220a updates, to the VLAN identifier transmitted to the terminal PC30 at step S200, the value in the VLAN ID field of an entry having, in the port number field, the port to which the external device that has transmitted the VLAN identifier at step S200 is connected (in other words, the port that has received the frame).

In addition to the MAC addresses (MAC_PC10 and MAC_PC20) of the two terminals (PC10 and PC20) that are already connected to the switch 100a, the MAC address (MAC_PC30) of the terminal PC30 that has been newly connected to the switch 100a is added to the permission list 420 stored inside the switch 100a through the above described No Auth initial process (FIG. 15). Furthermore, a VLAN identifier “2” of the port P503 the switch 100a, to which the terminal PC30 has been newly connected, is added to the VLAN defining information 430 stored in the switch 100a.

Similar to the case described in FIG. 6, for example, when the switch 100a is connected to still another switch, the switch 100a may transmit, to the still another switch, the frame including information stored in the updated permission list 420 and the VLAN defining information 430.

1-2. Authentication Process

In an authentication process of the second embodiment, instead of step S216 of the authentication process in the first embodiment described in FIG. 9, a process similar to step S200 and S202 described in FIG. 16 may be conducted. It should be noted that when the authentication process is conducted, the corresponding type of authentication is “EAP.” Therefore, based on the default VLAN information 440 described in FIG. 14, the VLAN identifier transmitted to the security management section 250a in the process similar to step S200 in FIG. 16 is “1.”

By having the process conducted as described above, for example, a virtual network identified by a VLAN identifier of “1” can be used as a network of for ordinary tasks, and a virtual network identified by a VLAN identifier of “2” can be used as a network only for accessing the Internet. With this, an operation can be conducted where an external device with which the authentication has succeeded is permitted to access the network for ordinary tasks, i.e., a network with a large volume of confidential information; and an external device for which the authentication has been omitted is not permitted to access the network with a large volume of confidential information. In other words, the virtual network can be used as means for ensuring security.

### 2. When Another Switch is Connected as a New External Device

### Specific Example 2

Even when another switch is connected to the switch 100a as a new external device, by conducting a process similar to the specific Example 1 in which a terminal is connected as an external device, an advantageous effect similar to the specific Example 1 can be obtained. Detail descriptions of it will be omitted.

As described above, when an external device (e.g., a terminal or another switch) is connected to the switch 100a according to the second embodiment of the present invention, different virtual network identifiers (VLAN identifier) are transmitted to an external device connected to the port configured of the first authentication type (No Auth) and to an external device connected to the port configured for the second authentication type (EAP). As a result, the switch 100a according to the second embodiment can achieve a further improvement in security.

<Modification 1>

The configurations of the switches shown in each of the embodiment described above are merely examples and other configurations may be adopted. For example, as described in the following, modifications such as an omission of a part of the components and a further addition of components can be devised.

Instead of using layer 2 switches to relay frames by using MAC addresses, the switches in each of the embodiments may be layer 3 switches that are further capable of relaying packets by using IP addresses. Furthermore, the switches in each of the embodiments may be so-called access points capable of relaying packets of wireless communication via wireless-communication interfaces.

Furthermore in the switches in each of the embodiments described above, although the authentication protocol lists, the permission lists, the VLAN defining information, and the default VLAN information are stored in a RAM, they may be stored in another storage medium (e.g., flash ROM).

Furthermore, descriptions have been provided for the switches in each of the embodiment as the CPU including the relay process section, the EAP authentication section, and the security management section, while the relay process section further including the authentication information management section and the MAC address authentication section. In addition, descriptions of the functions executed in each of the process sections have been provided. However, the allocations of each of the process sections and the functions accomplished by each of the process sections are merely examples, and may be arbitrarily changed depending on the configuration of the switch.

Furthermore, among the functions of the relay process section described in the embodiments, the frame relaying function may be a function attained by a physical chip that forms a wired communications interface, and other functions (the function of determining whether a received frame is eligible to be relayed, the function of the authentication information management section, and the function of the MAC address authentication section) of the relay process section may be functions attained by the CPU. In such a case, all the functions of the relay process section are attained through a cooperation of the CPU and the physical chip forming the wired communications interface. For example, the functions of the relay process section, the EAP authentication section, the security management section, the authentication information management section, and the MAC address authentication section may all be included inside the physical chip forming the wired communications interface.

<Modification 2>

In the embodiments described above, the switch includes: the MAC address authentication section for conducting a MAC address authentication of a received frame; and the EAP authentication section for conducting, when an external device is connected, authentication between the switch and the connect external device. In other words, a function of RADIUS (Remote Authentication Dial-In User Service) is built in the switch. However, a dedicated RADIUS server may be provided separate from the switch, and this external RADIUS server may conduct the actual MAC address authentication and the authentication with a connected external device. When a dedicated RADIUS server separate from the switch is provided, the functions of the MAC address authentication section and the EAP authentication section can be achieved by having the MAC address authentication section and the EAP authentication section transmit authentication requests to the RADIUS server to obtain authentication results as responses to the transmissions.

Furthermore, in each of the above described embodiments, if the type of authentication is EAP, an authentication using EAP-MD5 of IEEE 802.1X is conducted as the authentication protocol determined in advance. However, authentication protocols other than those described above as examples may be adopted.

Examples of the authentication protocols that can be adopted include EAP-TLS (extensible authentication protocol-transport layer security), EAP-TTLS (extensible authentication protocol-tunneled transport layer security), PEAP (Protected Extensible Authentication Protocol), LEAP (Lightweight Extensible Authentication Protocol), and other original methods using EAP protocol.

Furthermore, instead of the authentication protocol conforming to EAP protocol of IEEE 802.1X, the following authentication protocol may be used. Specifically, MAC addresses of external devices (other switches, terminals, and the like) that should be permitted to be connected are stored inside the switch in advance. Then, when an external device is connected and if the MAC address of the external device is a preregistered MAC address that should be permitted for connection, the EAP authentication section treats the external device as a partner with which the authentication has succeeded. By adopting such a configuration, an administrator of the switch or the like can designate in advance an external device that should be permitted for connection.

<Modification 3>

In the above described embodiments, examples of the authentication protocol list, the permission list, the VLAN defining information, and the default VLAN information have been shown in a table format. However, these tables are merely examples, and the format thereof may be arbitrarily determined without departing from the spirit and scope of the invention. For example, fields other than the fields described above may be included. In addition, direct-mapped method can be used on each of the tables. Furthermore, it is also desirable if each of the tables is configurable by the user.

Specifically, although the permission lists only store, without any distinctions of the port through which a frame has been received, transmission source MAC addresses that are eligible to be relayed; modifications as described in the following may be adopted. For example, by adding the port number field to the permission list, the transmission source MAC addresses, from which frames permitted to be relayed are received, may be managed by every port. Furthermore, for example, by providing a transmission source MAC address field and a relay-eligibility field instead of the permitted address field, a frame's eligibility/ineligibility to be relayed may be set for every transmission source MAC address.

It should be noted that, in each of the embodiments described above, although the CPU has achieved every configuration of the switch by executing a firmware or a computer program stored in a memory, each configuration of the present invention may be achieved by hardware or software.

Furthermore, when one part or all the functions of the present invention are achieved by software, the software (computer program) may be provided as being stored in a computer readable storage medium. In the present invention, the term “computer readable storage medium” is not limited to portable storage media such as flexible disks and CD-ROMs, but also includes internal storage devices of computers such as various RAMs, ROMs, and the like, and external storage devices such as hard disks and the like that are fixed on the computer.

While the invention has been described in detail, the foregoing description is in all aspects illustrative and not restrictive. For example, elements that are additional in light of the scope and spirit of the present invention can be omitted as appropriate. It will be understood that numerous other modifications and variations can be devised without departing from the scope of the invention.

What is claimed is:

1. A network relay device for relaying data frames received from external devices, the network relay device comprising:
a plurality of ports to which external devices connect, and configured pre-correlated with types of authentication to be conducted with respect to connected external devices, the types of authentication including a first authentication type and a second authentication type;
an authentication process section for conducting, when an external device is connected to the network relay device, mutual authentication between the network relay device and the external device in accordance with a type of authentication that the port to which the external device is connected is configured for; and
a relay process section for relaying, without authentication being conducted by the authentication process section, frames received through a port configured for the first authentication type as the type of authentication, and for relaying frames received through a port configured for the second authentication type as the type of authentication, if authentication by the authentication process section has succeeded.

2. The network relay device according to claim 1, further comprising a security management section for monitoring frames received from an external device connected to the port configured for the first authentication type.

3. The network relay device according to claim 2, wherein
the security management section detects whether a computer virus is contained in frames received from an external device connected to a port configured for the first authentication type.

4. The network relay device according to claim 2, wherein:
virtual network identifiers defining virtual subnetworks built by a virtual-subnetwork-constructing external device connected to the network relay device are stored in the network relay device; and
when a virtual-subnetwork-constructing external device is connected to the network relay device, the security management section transmits to said external device a virtual network identifier that differs depending on whether said external device is connected to a port configured for the first authentication type or a port configured for the second authentication type.

5. The network relay device according to claim 1, wherein:
a permission list for identifying, by the use of information included in frames received from an external device, frames that are relay-eligible is stored in the network relay device; and
the relay process section includes an authentication information management section for changing content stipulated in the permission list in response to an external device's state of connection.

6. The network relay device according to claim 5, wherein
the authentication information management section
if an external device is connected to a port configured for the first authentication type, changes the content stipulated in the permission list so as to enable relay of frames received from the connected external device, and
if an external device is connected to a port configured for the second authentication type and if the mutual authentication by the authentication process section has succeeded, changes the content stipulated in the permission list so as to enable relay of frames received from the connected external device.

7. The network relay device according to claim 5, wherein
if the permission list has been changed, the authentication information management section furthermore transmits the content of the changed permission list to a separate network relay device connected to said network relay device.

8. The network relay device according to claim 1, wherein
the authentication process section functions both as an authentication client based on IEEE 802.1X and as an authentication server based on IEEE 802.1X.

9. The network relay device according to claim 1, wherein
when a separate network relay device is connected to the network relay device and if the MAC address of the separate network relay device is pre-registered in the network relay device as a MAC address for which connection is to be permitted, the authentication process section treats the separate network relay device as a partner with which mutual authentication has succeeded.

10. A method executed by a network relay device for controlling relay of frames received from external devices, the method comprising:
a step of determining a type of authentication that a port of the network relay device to which an external device is connected is configured for;
a step of relaying, without mutual-authentication being conducted between the network relay device and the external device, frames received through a connection port configured for a first authentication type as the type of authentication;
a step of relaying frames received through a connection port configured for a second authentication type as the type of authentication, if mutual authentication has been successfully conducted between the network relay device and the external device in accordance with a predetermined authentication protocol; and
a step of monitoring the frames received from the external device connected to the port configured for the first authentication type, and determining whether the frames are relay-eligible.
